(19) United States
(12) Patent Application Publication
(10) Pub. No.: US 2026/0284556 A1
(43) Pub. Date: Sep. 24, 2026

(54) PLASMA SEPARATION APPARATUS AND PLASMA SEPARATION METHOD

(71) Applicant: Canon Medical Systems Corporation, Otawara-shi (JP)

(72) Inventors: Hiroto SATAKE, Brighton, MA (US); Kenta KAMINO, Shimotsuga (JP); Keisuke SUGAHARA, Nasushiobara (JP); Takuya KOYAMA, Toyama (JP); Shunsuke FUJIWARA, Utsunomiya (JP)

(73) Assignee: Canon Medical Systems Corporation, Otawara-shi (JP)

(21) Appl. No.: 19/567,807

(22) Filed: Mar. 16, 2026

(30) Foreign Application Priority Data
Mar. 18, 2025 (JP) 2025-043760

(51) Int. Cl. B01D 21/28; B01D 21/01; B01D 21/26; B01D 21/30; G01N 1/40; G01N 21/31

(52) U.S. Cl. CPC B01D 21/283; B01D 21/01; B01D 21/265; B01D 21/302; G01N 1/4077; G01N 21/31; G01N 2001/4094

(57) ABSTRACT

A plasma separation apparatus according to an embodiment includes an acoustic wave application unit, a detection unit, and a removal unit. The acoustic wave application unit applies acoustic waves to blood held in a holding unit to concentrate blood cells contained in the blood at a predetermined position of the holding unit. The detection unit detects information regarding a concentration state of the concentrated blood cells. The removal unit removes the concentrated blood cells based on the detected information to separate plasma from the blood.

### CROSS-REFERENCE TO RELATED APPLICATIONS

This application is based upon and claims the benefit of priority from Japanese Patent Application No. 2025-043760, filed Mar. 18, 2025, the entire contents of which are incorporated herein by reference.

### FIELD

Embodiments described herein relate generally to a plasma separation apparatus and a plasma separation method.

### BACKGROUND

Biochemical examination is an examination for chemically analyzing a sample (for example, blood, urine, or puncture fluid) from a living body. For example, in a conventional method, a sample contained in a centrifuging tube is centrifuged by a centrifuge. By centrifugation, a component with a low specific gravity (for example, a liquid component) is accumulated in an upper layer of the centrifuging tube, and a component with a higher specific gravity (for example, a solid component) is accumulated in a lower layer of the centrifuging tube. Subsequently, in the conventional method, the liquid component is aspirated from the upper layer of the centrifuging tube using a pipette and analyzed by an automated analytical apparatus.

However, the conventional method requires a machine, personnel, and time for centrifugation, and thus requires considerable cost and work. In particular, in a case where plasma is centrifuged from the blood, contents of red blood cells destroyed by the centrifugation may leak into plasma (hemolysis), which can affect a result of analysis of plasma.

### BRIEF DESCRIPTION OF THE DRAWINGS

FIG. 1 is a block diagram illustrating a configuration of a plasma separation apparatus;

FIG. 2 is a block diagram illustrating a configuration of a control apparatus;

FIG. 3 is a flowchart illustrating an operation performed by the plasma separation apparatus;

FIGS. 4A to 4C are views illustrating a process of adding blood;

FIGS. 5A to 5D are views illustrating a process of applying acoustic waves;

FIG. 6 is a time chart illustrating a method of controlling a frequency of acoustic waves;

FIGS. 7A and 7B are views illustrating a process of detecting a concentration state of blood cells with a camera;

FIG. 8 is a view illustrating a method of acquiring a pixel value of blood cells from a color image;

FIG. 9 is a graph illustrating a change in pixel value;

FIGS. 10A and 10B are views illustrating a process of detecting a concentration state of blood cells with a sensor;

FIG. 11 is a graph illustrating a change in absorbance;

FIG. 12 is a time chart illustrating a timing for determining whether to remove the blood cells;

FIGS. 13A and 13B are views illustrating a process of removing the blood cells; and

FIGS. 14A and 14B are views illustrating a process of collecting plasma.

### DETAILED DESCRIPTION

A plasma separation apparatus according to an embodiment includes an acoustic wave application unit, a detection unit, and a removal unit. The acoustic wave application unit applies acoustic waves to blood held in a holding unit to concentrate blood cells contained in the blood at a predetermined position of the holding unit. The detection unit detects information regarding a concentration state of the concentrated blood cells. The removal unit removes the concentrated blood cells based on the detected information to separate plasma from the blood.

Various Embodiments will be described hereinafter with reference to the accompanying drawings.

A plurality of portions denoted by the same reference number is regarded as identical portions, and redundant descriptions are omitted as appropriate.

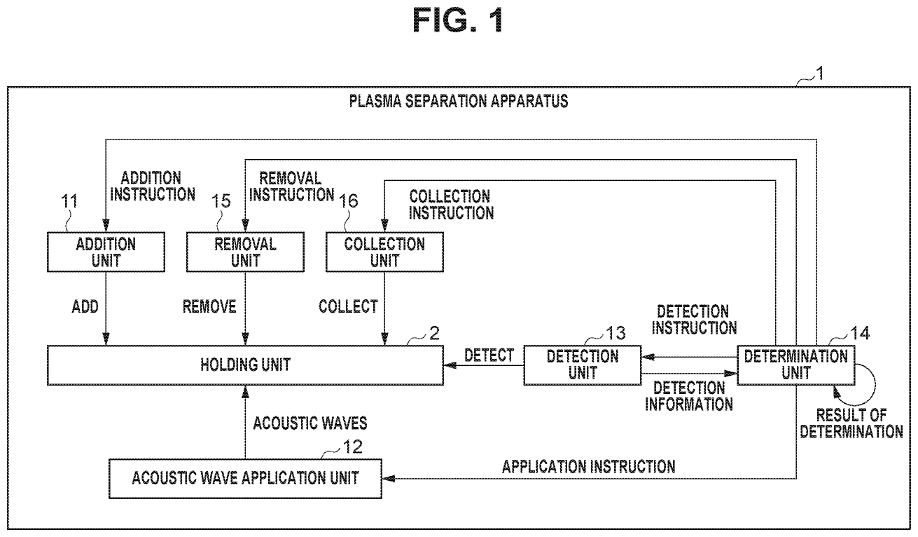

FIG. 1 is a block diagram illustrating a configuration of a plasma separation apparatus 1. The plasma separation apparatus 1 is an apparatus for separating plasma. The plasma separation apparatus 1 includes an addition unit 11, an acoustic wave application unit 12, a detection unit 13, a determination unit 14, a removal unit 15, and a collection unit 16. The plasma separation apparatus 1 may further include a holding unit 2.

The addition unit 11 adds (or dispenses) a liquid (for example, blood or agglutinating agent) to the holding unit 2 in accordance with an addition instruction from the determination unit 14. The addition unit 11 may be provided for each type of liquid to be added. The addition unit 11 is, for example, an electric pipette or an electric syringe.

The acoustic wave application unit 12 applies (or emits) acoustic waves to the blood held in the holding unit 2 in accordance with an application instruction from the determination unit 14. The acoustic wave application unit 12 applies acoustic waves to concentrate blood cells (for example, red blood cells and platelets) contained in the blood at a predetermined position of the holding unit 2 (for example, a central portion or the center). For example, the acoustic wave application unit 12 is a piezo-electric transducer or an interdigital transducer (IDT)).

The detection unit 13 detects information (for example, a color image or absorbance) regarding a concentration state of the blood cells concentrated in the holding unit 2 in accordance with a detection instruction from the determination unit 14. The detection unit 13 transmits the detected information (i.e., detection information) to the determination unit 14. The detection unit 13 is, for example, a camera or a sensor.

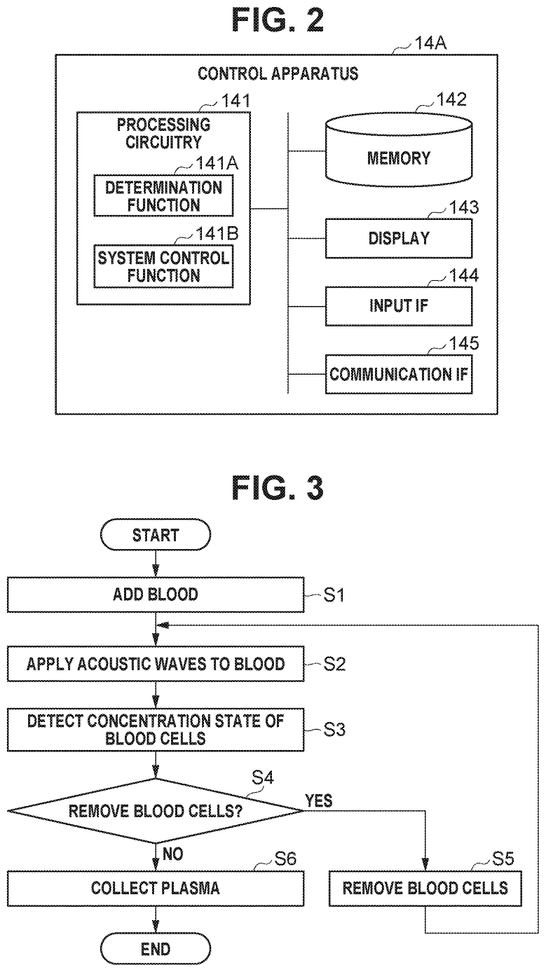

The determination unit 14 executes various kinds of determination to output various kinds of determination results. The determination unit 14 generates various kinds of instructions based on the various kinds of determination results that have been output. Firstly, the determination unit 14 transmits an addition instruction to add a liquid to the addition unit 11. Secondly, the determination unit 14 transmits an application instruction to apply acoustic waves to the acoustic wave application unit 12. Thirdly, the determination unit 14 transmits a removal instruction to remove blood cells to the removal unit 15. Fourthly, the determination unit 14 transmits a collection instruction to collect plasma to the collection unit 16. The determination unit 14 is, for example, a control apparatus (refer to FIG. 2).

For example, the determination unit 14 outputs a result of determination as to whether to remove the blood cells concentrated in the holding unit 2 based on the detection information from the detection unit 13. In a case where the result of determination is positive (i.e., the blood cells are to be removed), the determination unit 14 transmits the removal instruction to the removal unit 15. In a case where the result of determination is negative (i.e., the blood cells are not to be removed), the determination unit 14 does not transmit the removal instruction.

The removal unit 15 removes the blood cells from the holding unit 2 in accordance with the removal instruction from the determination unit 14. The removal unit 15 removes the blood cells to separate plasma from blood. The removal unit 15 is, for example, an electric pipette or an electric syringe.

The collection unit 16 collects plasma from the holding unit 2 in accordance with the collection instruction from the determination unit 14. The collection unit 16 is, for example, an electric pipette or an electric syringe.

The holding unit 2 holds blood. The holding unit 2 has a surface for holding blood (i.e., a holding surface). The holding surface may have any shape (for example, a circular shape or a polygonal shape). The holding unit 2 holds blood as a liquid layer or a liquid droplet on the holding surface. The holding unit 2 is, for example, a container or a substrate.

FIG. 2 is a block diagram illustrating a configuration of a control apparatus 14A. The control apparatus 14A includes, as various constituent elements, processing circuitry 141, a memory 142, a display 143, an input interface (IF) 144, and a communication IF 145. These constituent elements are communicably connected to each other via an internal bus. The control apparatus 14A is an example of the determination unit 14.

The processing circuitry 141 is circuitry that performs integrated control of the constituent elements of the control apparatus 14A. The processing circuitry 141 includes at least one processor. The processor is circuitry such as a central processing unit (CPU), a graphics processing unit (GPU), an application specific integrated circuit (ASIC), or a programmable logic device (PLD). The PLD is circuitry such as a simple programmable logic device (SPLD), a complex programmable logic device (CPLD), or a field programmable gate array (FPGA).

In a case where the processor is the CPU, the CPU reads out various kinds of programs stored in the memory 142 and executes the programs to implement various kinds of functions. In a case where the processor is the ASIC, various kinds of functions are incorporated as logic circuitry in the ASIC. The processor may be configured as a single piece of circuitry or a combination of a plurality of pieces of circuitry. The processor implements a determination function 141A and a system control function 141B.

The determination function 141A is a function of, by executing various kinds of determination, outputting various kinds of determination results. The determination function 141A generates various kinds of instructions based on the various kinds of determination results that are output and transmits the instructions. The determination function 141A is an example of the determination unit 14.

The system control function 141B is a function of performing integrated control of the constituent elements of the control apparatus 14A. The system control function 141B provides the processing circuitry 141 with an operating system (OS) to implement various kinds of functions. The system control function 141B is an example of a system control unit.

The memory 142 is a device that stores various kinds of data. The memory 142 is a magnetic disk, a semiconductor memory, or the like. The memory 142 stores various kinds of programs to be executed by the processing circuitry 141. The memory 142 is an example of a storage unit.

The display 143 is a device that displays various kinds of data. The display 143 is a liquid crystal display, an organic electro-luminescence (EL) display, or the like. The display 143 may have a function of the input IF 144. The display 143 is an example of a display unit.

The input IF 144 is an interface that accepts an input operation from an operator. The input IF 144 is a mouse, a keyboard, a button, a switch, a trackball, a touch panel, or the like. The input IF 144 converts the input operation from the operator into an electric signal, and transmits the electric signal to the processing circuitry 141. The input IF 144 is an example of the input unit.

The communication IF 145 is an interface that communicates various kinds of data. The communication IF 145 may communicate with an external apparatus through a network. The communication IF 145 is an example of a communication unit.

FIG. 3 is a flowchart illustrating an operation performed by the plasma separation apparatus 1. The plasma separation apparatus 1 executes steps S1 to S6, and repeatedly executes steps S2 to S5.

### Step S1

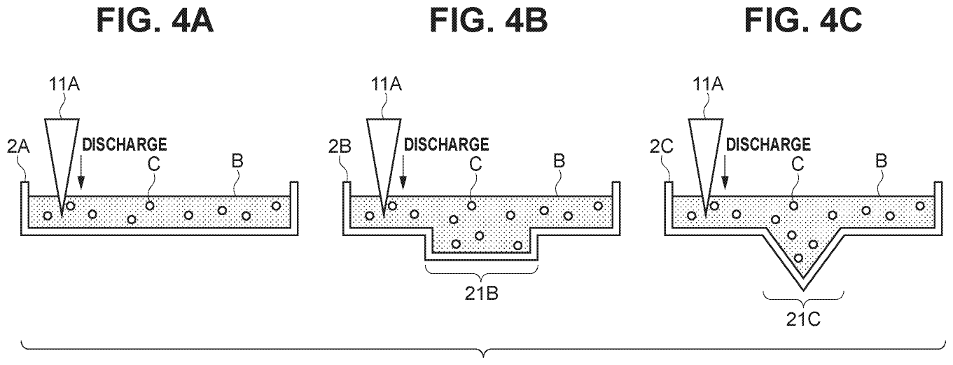

First, the addition unit 11 adds blood (see FIGS. 4A to 4C). Specifically, the addition unit 11 adds the blood to the holding unit 2 in accordance with the addition instruction from the determination unit 14. The determination unit 14 may transmit the addition instruction to the addition unit 11 in response to a start operation from the operator. The added blood is held by the holding unit 2.

### Step S2

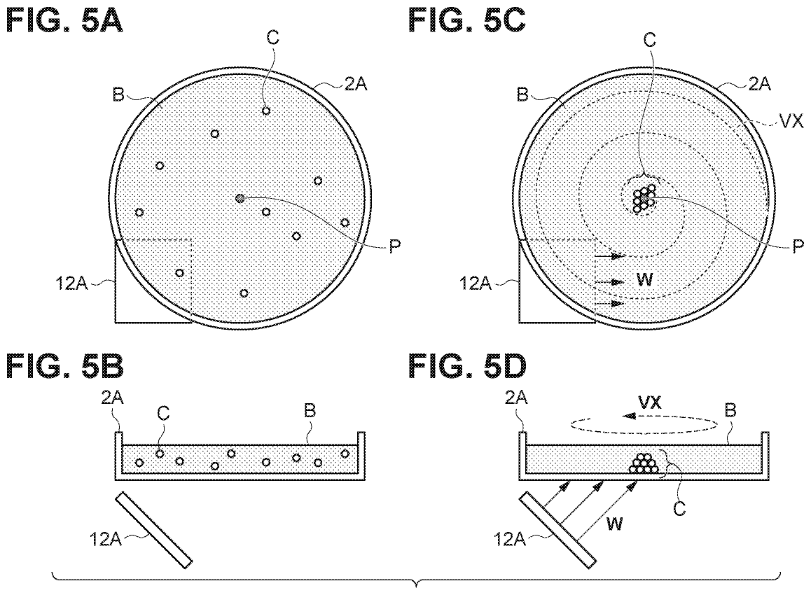

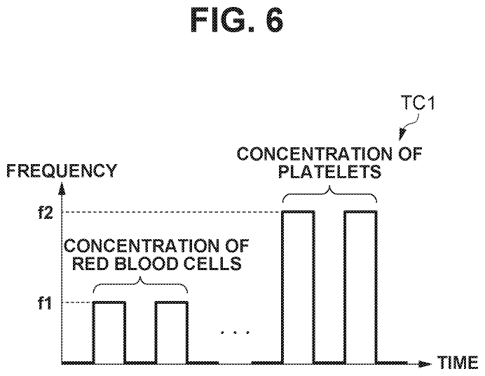

Next, the acoustic wave application unit 12 applies acoustic waves to the blood (see FIGS. 5A to 5D and 6). Specifically, the acoustic wave application unit 12 applies the acoustic waves to the blood held in the holding unit 2 in accordance with the application instruction from the determination unit 14. The determination unit 14 may transmit the application instruction to the acoustic wave application unit 12 at a timing at which step S1 ends. By applying the acoustic waves, blood cells contained in the blood are concentrated at a predetermined position in the holding unit 2.

### Step S3

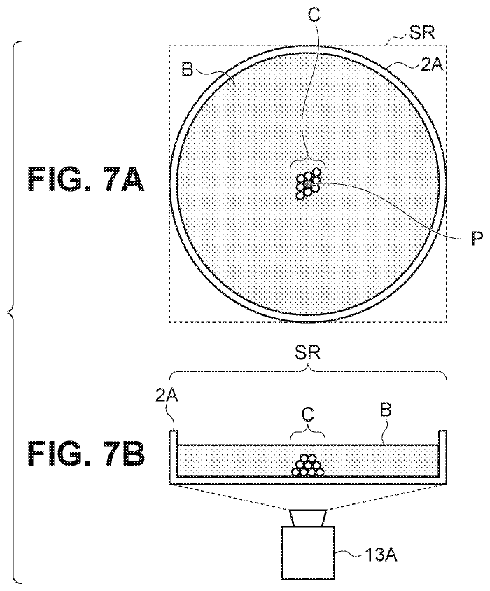

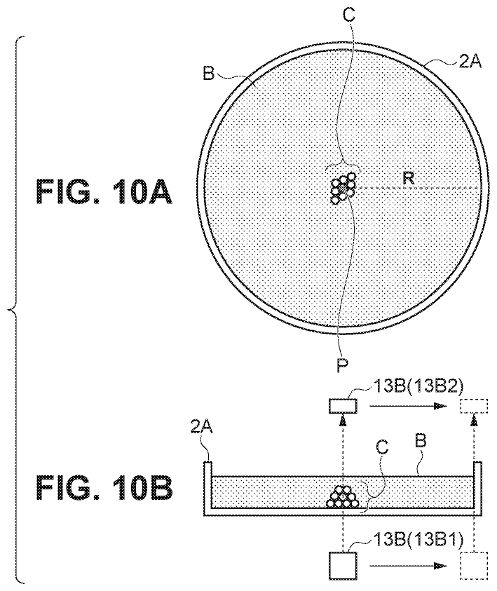

Subsequently, the detection unit 13 detects a concentration state of the blood cells (see FIGS. 7A, 7B, 10A, and 10B). Specifically, the detection unit 13 detects information (detection information) regarding the concentration state of the blood cells concentrated in the holding unit 2 in accordance with the detection instruction from the determination unit 14. The determination unit 14 may transmit the detection instruction to the detection unit 13 at a timing at which step S2 ends. The detection information may be information regarding the number or distribution of blood cells.

### Step S4

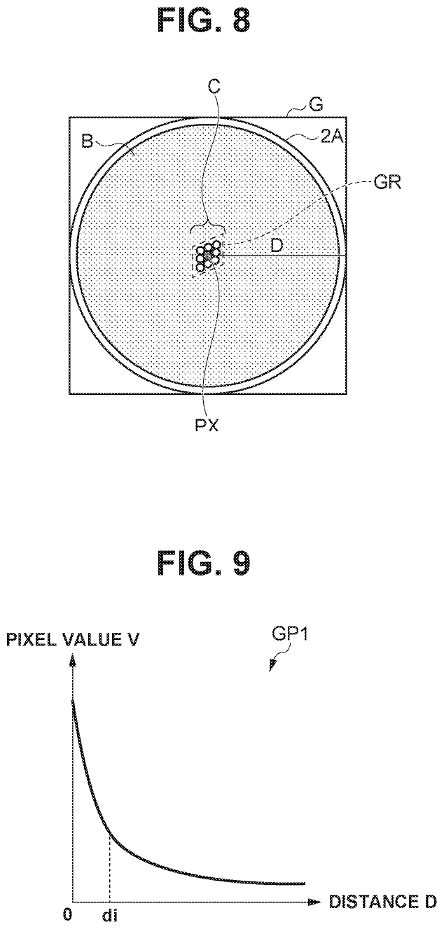

Subsequently, the determination unit 14 determines whether to remove the blood cells (see FIGS. 8, 9, 11, and 12). Specifically, the determination unit 14 outputs a result of determination as to whether to remove the blood cells concentrated in the holding unit 2 based on the detection information from the detection unit 13. In a case where the result of determination is positive (YES in step S4), the processing proceeds to step S5. In a case where the result of determination is negative (NO in step S4), the processing proceeds to step S6.

### Step S5

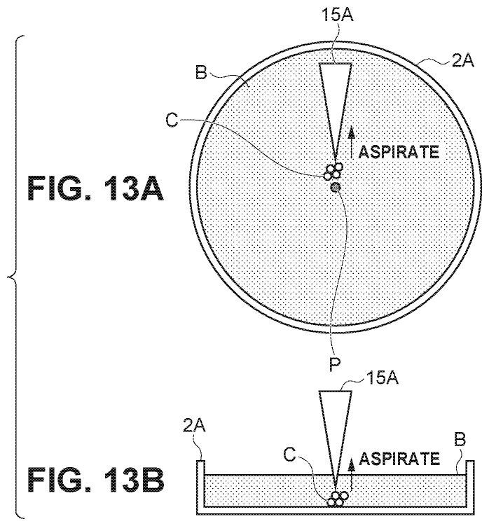

Subsequently, the removal unit 15 removes the blood cells (see FIGS. 13A and 13B). Specifically, the removal unit 15 removes the blood cells concentrated in the holding unit 2 in accordance with the removal instruction from the determination unit 14. The determination unit 14 may transmit the removal instruction to the removal unit 15 in response to the positive result of determination output in step S4. By removal of the blood cells, plasma is separated from the blood. After step S5, the processing returns to step S2.

### Step S6

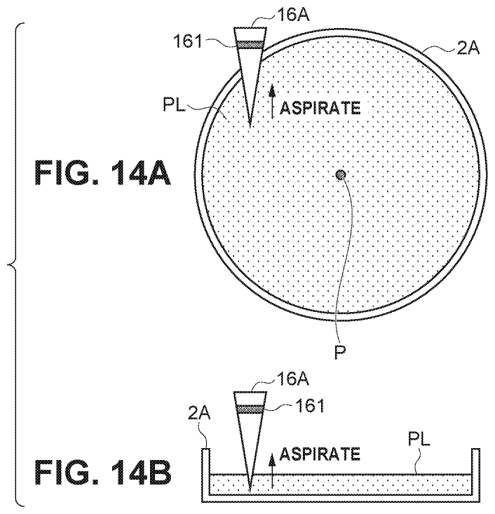

Finally, the collection unit 16 collects the plasma (see FIGS. 14A and 14B). Specifically, the collection unit 16 collects the plasma from the holding unit 2 in accordance with the collection instruction from the determination unit 14. The determination unit 14 may transmit the collection instruction to the collection unit 16 in response to the negative result of determination output in step S4.

FIGS. 4A to 4C are views illustrating a process of adding blood B. FIGS. 4A, 4B, and 4C are front views illustrating the process of discharging the blood B to petri dishes 2A, 2B, and 2C, respectively, with an electric pipette 11A. The electric pipette 11A is a pipette that executes aspiration and discharge of a liquid under electronic control. The petri dishes 2A, 2B, and 2C are dishes made of glass or plastic and each having a circular bottom surface (i.e., the holding surface). The electric pipette 11A is an example of the addition unit 11. Each of the petri dishes 2A, 2B, and 2C is an example of the holding unit 2.

As illustrated in FIGS. 4A, 4B, and 4C, the electric pipette 11A discharges the blood B from above the petri dishes 2A, 2B, and 2C toward the bottom surfaces of the petri dishes 2A, 2B, and 2C, respectively. The blood B contains blood cells C and plasma. Each of the petri dishes 2A, 2B, and 2C holds the discharged blood B as a liquid layer.

The petri dish 2B has a columnar dent 21B (i.e., a cross section thereof isa rectangle) at a central portion of the bottom surface, and the petri dish 2C has a conical dent 21C (i.e., a cross section thereof is a triangle) at a central portion of the bottom surface. Each of the dents 21B and 21C has a depth larger than that of a peripheral portion, and can thereby effectively collect the blood cells C concentrated at the central portion of the bottom surface. Each of the dents 21B and 21C may have any shape (for example, a hemispherical shape or a polyhedral shape).

FIGS. 5A to 5D are views illustrating a process of applying acoustic waves W. FIGS. 5A and 5B are top and front views, respectively, each illustrating the petri dish 2A and a piezoelectric transducer 12A before application of the acoustic waves W. FIGS. 5C and 5D are top and front views, respectively, each illustrating the petri dish 2A and the piezoelectric transducer 12A after (or during) the application of the acoustic waves W. The piezoelectric transducer 12A is a device that vibrates at a predetermined frequency to generate the acoustic waves W (in particular, ultrasonic waves). The piezoelectric transducer 12A is an example of the acoustic wave application unit 12.

As illustrated in FIGS. 5A and 5B, the piezoelectric transducer 12A is disposed below the petri dish 2A spaced apart from a center P of the petri dish 2A. The piezoelectric transducer 12A is disposed to be inclined at a predetermined angle (for example, 45°) relative to the bottom surface of the petri dish 2A. A couplant for effectively transmitting the acoustic waves W may be disposed between the piezoelectric transducer 12A and the petri dish 2A.

As illustrated in FIGS. 5C and 5D, the piezoelectric transducer 12A applies the acoustic waves W along a circumferential direction of the petri dish 2A (in particular, a circumferential direction of the bottom surface). The acoustic waves W reach the blood B held in the petri dish 2A through the bottom surface of the petri dish 2A. By an acoustic radiation force, the acoustic waves W press the blood cells C contained in the blood B along a traveling direction of the acoustic waves W. The pressed blood cells C collide with a side surface of the petri dish 2A inclined relative to the traveling direction of the acoustic waves W, and thereby flow along the circumferential direction of the petri dish 2A. As a result, a vortex VX of an acoustic flow (i.e., acoustic streaming) toward the center P of the petri dish 2A is generated, and the blood cells C are concentrated at the center of the vortex VX. The center of the vortex VX coincides with the center P of the petri dish 2A.

FIG. 6 is a time chart TC1 illustrating a method of controlling a frequency of the acoustic waves W. As illustrated in the time chart TC1, the acoustic wave application unit 12 may control the frequency of the acoustic waves W based on a type (or size) of the blood cells C. The acoustic wave application unit 12 may intermittently (or repeatedly) apply the acoustic waves W of a predetermined frequency. At this time, a temporal change in frequency is expressed by a rectangular wave. The determination unit 14 may adjust a frequency parameter included in the application instruction to control the frequency of the acoustic waves W applied by the acoustic wave application unit 12.

When the blood cells C flow in the vortex VX, an acoustic radiation force in a direction toward the center of the vortex VX (centripetal direction) acts on the blood cells C, while a centrifugal force in a direction away from the center of the vortex VX (centrifugal direction) acts on the blood cells C. In a case where the acoustic radiation force is larger than the centrifugal force (acoustic radiation force>centrifugal force), the blood cells C flow in the direction toward the center of the vortex VX. In a case where the acoustic radiation force is smaller than the centrifugal force (acoustic radiation force<centrifugal force), the blood cells C flow in the direction away the center of the vortex VX. The acoustic radiation force increases as the size of the blood cells C increases, and also increases as the frequency of the acoustic waves W increases. The centrifugal force increases as the size of the blood cells C increases.

Thus, the acoustic wave application unit 12 controls the frequency of the acoustic waves W based on the type (or size) of the blood cells C, and can thereby concentrate the blood cells C of a desired type (or size) at the center of the vortex VX. The type of the blood cells C to be concentrated may be set by the operator or the like. For example, in a case where red blood cells (diameter: 7 to 8 μm) are to be concentrated as the blood cells C, the acoustic wave application unit 12 applies the acoustic waves W to the blood B at a first frequency f1. In a case where platelets (diameter: 2 to 4 μm) are to be concentrated as the blood cells C, the acoustic wave application unit 12 applies the acoustic waves W to the blood B at a second frequency f2 that is higher than the first frequency f1.

In a case where the acoustic waves W of the same frequency are applied, acoustic radiation force acting on the platelets is smaller than acoustic radiation force acting on the red blood cells. By applying the acoustic waves W of a higher frequency, the acoustic wave application unit 12 can concentrate the blood cells C having a smaller size.

In particular, the acoustic wave application unit 12 may apply the acoustic waves W of the first frequency f1 and thereafter apply the acoustic waves W of the second frequency f2. As a result, the blood cells C having a larger size (in particular, red blood cells) are concentrated, and thereafter the blood cells C having a smaller size (in particular, platelets) are concentrated. Since the removal unit 15 is capable of removing the red blood cells before removing the platelets, it is possible to prevent destruction of the red blood cells (hemolysis).

The acoustic radiation force by the acoustic waves W of the second frequency f2 is larger than the acoustic radiation force by the acoustic waves W of the first frequency f1. In a case where the acoustic waves W of the second frequency f2 are applied, the blood cells C having the larger size, in addition to the blood cells C having the smaller size, may be simultaneously concentrated. As a result, a large number of blood cells C (in particular, the red blood cells and the platelets) may collide with each other, and the red blood cells may be destroyed. Thus, it is desirable that the acoustic wave application unit 12 apply the acoustic waves W of the first frequency f1 and then apply the acoustic waves W of the second frequency f2.

Furthermore, the acoustic wave application unit 12 may set the frequency of the acoustic waves W based on a result of determination regarding the concentration state of the blood cells C by the determination unit 14. For example, in a case where the determination unit 14 determines that mainly the “red blood cells” are concentrated as the blood cells C, the acoustic wave application unit 12 sets the frequency of the acoustic waves W to the first frequency f1. In contrast, in a case where the determination unit 14 determines that mainly the “platelets” are concentrated as the blood cells C, the acoustic wave application unit 12 sets the frequency of the acoustic waves W to the second frequency f2. As a result, the acoustic wave application unit 12 is capable of switching the frequency of the acoustic waves W at an appropriate timing depending on the type of the concentrated blood cells C.

FIGS. 7A and 7B are views illustrating a process of detecting the concentration state of the blood cells C with a camera 13A. FIGS. 7A and 7B are top and front views, respectively, each illustrating the concentration state of the blood cells C at the center P of the petri dish 2A. The camera 13A is a device that captures a color image of the concentrated blood cells C. The camera 13A is an example of the detection unit 13.

As illustrated in FIGS. 7A and 7B, the camera 13A is installed below the petri dish 2A at the center P of the petri dish 2A. The camera 13A captures a color image so that the entire bottom surface of the petri dish 2A is included in an imaging region SR. The center of the imaging region SR coincides with the center P of the petri dish 2A. The camera 13A transmits the color image to the determination unit 14.

FIG. 8 is a view illustrating a method of acquiring a pixel value of the blood cells C from a color image G. A size of the color image G corresponds to the imaging region SR of the camera 13A. Each pixel in the color image G includes color information (for example, a red (R), green (G), and blue (B) value or a cyan (C), magenta (M), yellow (Y), and black (K) value). A center pixel PX of the color image G coincides with the center P of the petri dish 2A. A distance D is a distance from the center pixel PX (or the center P) along a radial direction of the petri dish 2A.

For example, the determination unit 14 identifies an image region GR corresponding to the blood cells C in the color image G. The determination unit 14 acquires a pixel value (an RGB value or a CMYK value) corresponding to a color of the blood cells C from the image region GR. Alternatively, the determination unit 14 may acquire a plurality of pixel values from a plurality of pixels constituting the image region GR, and acquire a statistical value based on the plurality of pixel values. The determination unit 14 compares the acquired pixel value (or the statistical value) and a threshold, and thereby outputs a result of determination as to whether to remove the blood cells C. Examples of the statistical value include minimum value, maximum value, median, mean, range, variance, standard deviation, skewness, and kurtosis.

Alternatively, the determination unit 14 may not identify the image region GR. The determination unit 14 may acquire the pixel value corresponding to the color of the blood cells C for each distance D.

FIG. 9 is a graph GP1 illustrating a change in pixel value V. The graph GP1 illustrates the change in pixel value V with respect to the distance D. The graph GP1 may be acquired for each type of color value (e.g., an R value, a G value, and a B value). For example, the pixel value V is the R value corresponding to the color of the red blood cells. The R value is an index indicating the number of the red blood cells.

As illustrated in the graph GP1, as the distance D increases, the pixel value V decreases. Specifically, when the distance D increases from 0 to di, the pixel value V sharply decreases. When the distance D increases from di, the pixel value V gradually decreases. The distance di is a distance at which a differential coefficient obtained by differentiating the pixel value V with respect to the distance D takes a predetermined value (e.g., −1).

In other words, the graph GP1 illustrates that a large number of red blood cells are concentrated near the center P of the petri dish 2A (in particular, when the distance D<di). The graph GP1 also illustrates that the number of red blood cells decreases with distance from the center P of the petri dish 2A (in particular, when the distance D>di).

FIGS. 10A and 10B are views illustrating a process of detecting the concentration state of the blood cells C with a sensor 13B. FIGS. 10A and 10B are top and front views, respectively, each illustrating the concentration state of the blood cells C at the center P of the petri dish 2A. The sensor 13B is a sensor that measures absorbance of the concentrated blood cells C (i.e., an absorbance sensor). The sensor 13B includes a light source 13B1 and a detector 13B2. The sensor 13B is an example of the detection unit 13.

As illustrated in FIGS. 10A and 10B, the sensor 13B is disposed so as to sandwich the petri dish 2A at the center P of the petri dish 2A. Specifically, the light source 13B1 is installed below the petri dish 2A, and the detector 13B2 is installed above the petri dish 2A. The light source 13B1 emits light of a predetermined wavelength toward the detector 13B2. Part of the emitted light is absorbed by the blood cells C held in the petri dish 2A. The detector 13B2 detects intensity (i.e., absorbance) of the absorbed light. The detector 13B2 transmits the absorbance to the determination unit 14.

The sensor 13B may measure absorbance of a wavelength corresponding to the color of the blood cells C. In a case where the blood cells C are red blood cells, the sensor 13B may measure the absorbance of a wavelength (for example, 400 nm) corresponding to the color of the red blood cells (in particular, red). The color of the red blood cells is exhibited by hemoglobin.

Furthermore, the sensor 13B may measure, while moving in a direction along a radius R of the petri dish 2A (i.e., a radial direction), the absorbance at each position after the movement. The sensor 13B may move along a rail extending in the radial direction of the petri dish 2A. As a result, the sensor 13B is capable of measuring the absorbance corresponding to the color of the blood cells C for each distance D in the radial direction. Alternatively, a row of sensors 13B may be arranged along the radial direction of the petri dish 2A, and each sensor 13B may measure the absorbance.

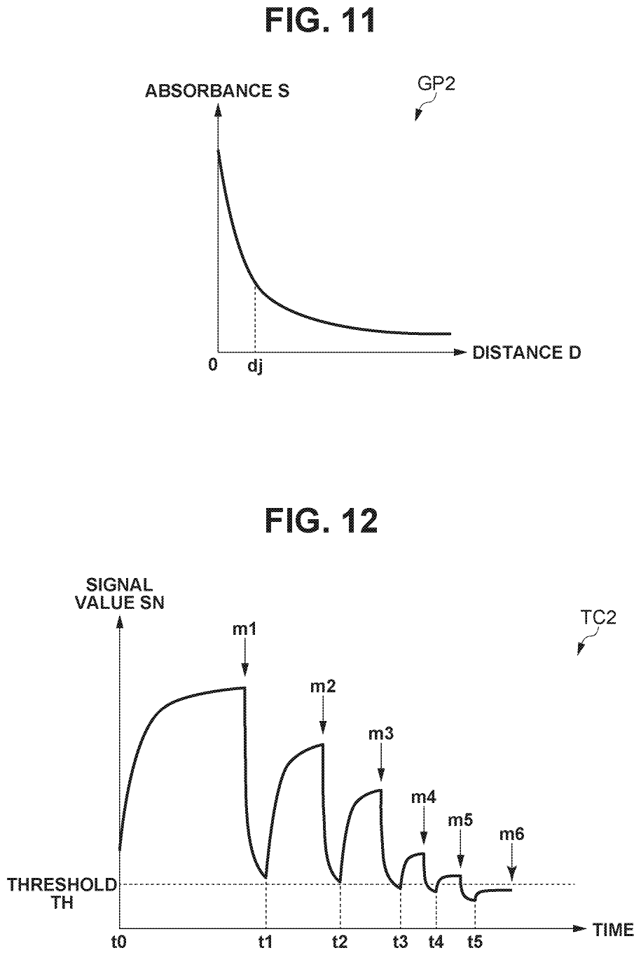

FIG. 11 is a graph GP2 illustrating a change in absorbance S. The graph GP2 illustrates the change in absorbance S with respect to the distance D. The graph GP2 may be acquired for each wavelength. For example, the absorbance S is an absorbance at a wavelength of 400 nm corresponding to the color of the red blood cells. The absorbance is an index indicating the number of red blood cells.

As illustrated in the graph GP2, as the distance D increases, the absorbance S decreases. Specifically, when the distance D increases from 0 to dj, the absorbance S sharply decreases. When the distance D increases from dj, the absorbance S gradually decreases. The distance dj is a distance at which a differential coefficient obtained by differentiating the absorbance S with respect to the distance D takes a predetermined value (e.g., −1).

In other words, the graph GP2 illustrates that a large number of red blood cells are concentrated near the center P of the petri dish 2A (in particular, when the distance D<dj). The graph GP2 also illustrates that the number of red blood cells decreases with distance from the center P of the petri dish 2A (in particular, when the distance D>dj). The graph GP2 is similar to the graph GP1.

FIG. 12 is a time chart TC2 illustrating a timing for determining whether to remove the blood cells C. The time chart TC2 illustrates a temporal change in signal value SN (e.g., the pixel value V or the absorbance S) at the center P of the petri dish 2A (i.e., the distance D=0). Specifically, the time chart TC2 illustrates the temporal change in the signal value SN when the plasma separation apparatus 1 repeatedly executes the concentration process (step S2) and the removal process (step S5) on the blood cells C. The N-th (N: natural number) concentration and removal processes correspond to a period of time from time t(N−1) to time t(N).

The first concentration and removal processes correspond to a period of time from time t0 to time t1. In the concentration process, the signal value SN sharply increases from the time t0, and then gradually increases so as to approach a plateau. The determination unit 14 compares the signal value SN with a threshold TH at a timing m1 at which a temporal change in the signal value SN reaches the plateau (step S4). For example, the determination unit 14 determines whether the signal value SN is the threshold TH or more. Since the signal value SN is the threshold TH or more at the timing m1, the determination unit 14 determines that the blood cells C are to be removed (YES in step S4). The determination unit 14 transmits a removal instruction to remove the blood cells C to the removal unit 15 based on this result of determination. In the removal process, the removal unit 15 removes the blood cells C in accordance with the removal instruction from the determination unit 14 (step S5). As a result, the signal value SN sharply decreases until the time t1.

The determination unit 14 may determine a timing at which a differential coefficient obtained by differentiating the signal value SN with respect to time reaches a predetermined value (in particular, a positive value close to 0) as the timing m1 at which the signal value SN reaches the plateau. The threshold TH may be set to any value by the operator or the like.

Similarly, the determination unit 14 determines a timing m(N) at which the temporal change in the signal value SN reaches the plateau in the N-th concentration and removal processes. The determination unit 14 determines whether the signal value SN is the threshold TH or more at the timing m(N). The determination unit 14 determines that the signal value SN at each of the timings m2 to m5 is the threshold TH or more (YES in step S4). The removal unit 15 repeatedly removes the blood cells C, whereby the signal value SN when reaching the plateau decreases stepwise.

Since the signal value SN is less than the threshold TH at the timing m6, the determination unit 14 determines that the blood cells C are not to be removed (NO in step S4). The determination unit 14 transmits a collection instruction to collect plasma to the collection unit 16 based on this result of determination. The collection unit 16 collects the plasma in accordance with the collection instruction from the determination unit 14.

FIGS. 13A and 13B are views illustrating a process of removing the blood cells C. FIGS. 13A and 13B are top and front views, respectively, each illustrating the process of removing the blood cells C from the petri dish 2A with an electric pipette 15A. The electric pipette 15A is similar to the electric pipette 11A. The electric pipette 15A is an example of the removal unit 15.

As illustrated in FIGS. 13A and 13B, the electric pipette 15A aspirates the blood cells C from above the petri dish 2A and removes the blood cells C. By removal of the blood cells C from the blood B, the plasma is separated from the blood B. The electric pipette 15A may aspirate the blood cells C from below the petri dish 2A and remove the blood cells C through an opening formed in the bottom surface of the petri dish 2A.

FIGS. 14A and 14B are views illustrating a process of collecting plasma PL. FIGS. 14A and 14B are top and front views, respectively, each illustrating a process of collecting the plasma PL from the petri dish 2A with an electric pipette 16A. The electric pipette 16A includes a filter 161. The electric pipette 16A may not include the filter 161. The electric pipette 16A is an example of the collection unit 16.

As illustrated in FIGS. 14A and 14B, the electric pipette 16A aspirates the plasma PL from above the petri dish 2A and collects the plasma PL. The electric pipette 16A may aspirate the plasma PL from below the petri dish 2A and collect the plasma PL through an opening formed in the bottom surface of the petri dish 2A. The electric pipette 16A filters the blood cells C that may remain in the plasma PL through the filter 161 and can thereby effectively purify the plasma PL.

According to the above-mentioned embodiment, the plasma separation apparatus 1 applies the acoustic waves W to the blood held in the holding unit 2 via the acoustic wave application unit 12. By applying the acoustic waves W, the blood cells contained in the blood are concentrated at the predetermined position of the holding unit 2. The plasma separation apparatus 1 detects information (detection information) regarding the concentration state of the blood cells via the detection unit 13. The plasma separation apparatus 1 outputs a result of determination as to whether to remove the blood cells based on the detection information via the determination unit 14. The plasma separation apparatus 1 removes the blood cells in accordance with the instruction (removal instruction) based on the result of determination via the removal unit 15. By removing the blood cells, the plasma is separated from the blood.

Unlike the conventional method, the plasma separation apparatus 1 does not require a machine, personnel, or time for centrifugation, which eliminates cost and labor for centrifugation. Thus, the plasma separation apparatus 1 is capable of easily separating the plasma from the blood. Furthermore, since the plasma separation apparatus 1 does not execute centrifugation, it is possible to prevent leakage of contents from red blood cells destroyed by centrifugation (hemolysis) into the plasma, and prevent the leakage from affecting a result of analysis of the plasma. Thus, the plasma separation apparatus 1 is capable of effectively purifying the plasma.

The plasma separation apparatus 1 applies the acoustic waves W particularly along the circumferential direction of the holding unit 2. As a result, a vortex of the acoustic flow toward the center of the holding unit 2 is generated, and the blood cells are concentrated at the center of the vortex. Thus, the plasma separation apparatus 1 is capable of concentrating the blood cells at the center of the holding unit 2.

Part of the blood concentrated at the center of the vortex can flow in a direction away from the center of the vortex. Part of the blood cells can flow in a similar direction along such a flow (i.e., centrifugal flow). If the plasma separation apparatus 1 removes the blood cells through one concentration process (step S2) and one removal process (step S5), there is a possibility that the plasma cannot be effectively purified due to the influence of the centrifugal flow.

Accordingly, the plasma separation apparatus 1 removes the blood cells through multiple concentration processes (step S2) and removal processes (step S5). Thus, the plasma separation apparatus 1 is capable of more effectively purifying the plasma in comparison with the case of executing one concentration process and one removal process.

### First Modification

Firstly, the plasma separation apparatus 1 may add, to the blood, an agglutinating agent (i.e., a blood cell agglutinating agent) that agglutinates the blood cells via the addition unit 11. As an agglutinating agent for red blood cells, polybrene may be used. For example, the addition unit 11 adds the blood cell agglutinating agent to the holding unit 2 in the process of adding the blood (step S1) or the process of concentrating the blood cells (step S2). The removal unit 15 removes the blood cells agglutinated by the blood cell agglutinating agent in the process of removing the blood cells (step S5). Thus, the plasma separation apparatus 1 is capable of effectively purifying the plasma in comparison with a case in which the blood cell agglutinating agent is not added.

### Second Modification

Secondly, the plasma separation apparatus 1 may detect the concentration state of the blood cells and determine whether to remove the blood cells (steps S3 and S4) at a timing at which a first predetermined time has elapsed since the start of the process of concentrating the blood cells (step S2), via the detection unit 13 and the determination unit 14. The determination unit 14 may determine whether the signal value SN is equal to or greater than the threshold TH at the timing at which the first predetermined time has elapsed. In a case where the signal value SN is less than the threshold TH, the determination unit 14 may execute similar determination again at a timing at which a second predetermined time has further elapsed. As a result, the determination unit 14 is capable of determining whether to remove the blood cells at a timing at which a sufficient time has elapsed since the start of the process of concentrating the blood cells (i.e., a timing at which the blood cells are assumed to be sufficiently concentrated). The first predetermined time and the second predetermined time may be set to any values by the operator or the like.

### Third Modification

Thirdly, the plasma separation apparatus 1 may include at least one of the camera 13A and the sensor 13B as the detection unit 13. The plasma separation apparatus 1 may detect the concentration state of the blood cells using at least one of the camera 13A and the sensor 13B.

According to at least one of the above-described embodiments, it is possible to easily separate the plasma from the blood.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A plasma separation apparatus comprising:
an acoustic wave application unit configured to apply acoustic waves to blood held in a holding unit to concentrate blood cells contained in the blood at a predetermined position of the holding unit;
a detection unit configured to detect information regarding a concentration state of the concentrated blood cells; and
a removal unit configured to remove the concentrated blood cells based on the detected information to separate plasma from the blood.

2. The plasma separation apparatus according to claim 1, wherein the acoustic wave application unit is configured to apply the acoustic waves along a circumferential direction of the holding unit to generate a vortex of an acoustic flow toward a center of the holding unit and concentrate the blood cells at the center of the vortex.

3. The plasma separation apparatus according to claim 1, wherein the acoustic wave application unit is configured to control a frequency of the acoustic waves based on a type of the blood cells.

4. The plasma separation apparatus according to claim 1, wherein the acoustic wave application unit is configured to apply acoustic waves of a first frequency to the blood and thereafter apply acoustic waves of a second frequency that is higher than the first frequency to the blood.

5. The plasma separation apparatus according to claim 1, further comprising a determination unit configured to output a result of determination as to whether to remove the concentrated blood cells based on the detected information,
wherein the removal unit is configured to remove the concentrated blood cells based on the output result of determination.

6. The plasma separation apparatus according to claim 5,
wherein the detection unit is a camera configured to capture a color image of the concentrated blood cells, and
wherein the determination unit is configured to output the result of determination based on the captured color image.

7. The plasma separation apparatus according to claim 6, wherein the determination unit is configured to acquire a pixel value corresponding to a color of the concentrated blood cells from an image region corresponding to the concentrated blood cells in the color image and compare the acquired pixel value with a threshold to output the result of determination.

8. The plasma separation apparatus according to claim 7, wherein the determination unit is configured to compare the pixel value with the threshold at a timing at which a temporal change in the pixel value reaches a plateau.

9. The plasma separation apparatus according to claim 5,
wherein the detection unit is a sensor configured to measure absorbance of the concentrated blood cells, and
wherein the determination unit is configured to output the result of determination based on the measured absorbance.

10. The plasma separation apparatus according to claim 9, wherein the determination unit is configured to acquire absorbance of a wavelength corresponding to a color of the concentrated blood cells and compare the acquired absorbance with a threshold to output the result of determination.

11. The plasma separation apparatus according to claim 10, wherein the determination unit is configured to compare the absorbance with the threshold at a timing at which a temporal change in the absorbance reaches a plateau.

12. The plasma separation apparatus according to claim 1, further comprising an addition unit configured to add, to the blood, an agglutinating agent to agglutinate the blood cells.

13. A plasma separation method comprising:
applying acoustic waves to blood held in a holding unit to concentrate blood cells contained in the blood at a predetermined position of the holding unit;
detecting information regarding a concentration state of the concentrated blood cells; and
removing the concentrated blood cells based on the detected information to separate plasma from the blood.
